(19) United States
(12) Patent Application Publication
(10) Pub. No.: US 2015/0106091 A1
(43) Pub. Date: Apr. 16, 2015

(54) CONFERENCE TRANSCRIPTION SYSTEM AND METHOD

(71) Applicants: Spence Wetjen, Austin, TX (US); Charles Rowe, Austin, TX (US); Adam Larsen, Austin, TX (US); Tom Shepard, Austin, TX (US)

(72) Inventors: Spence Wetjen, Austin, TX (US); Charles Rowe, Austin, TX (US); Adam Larsen, Austin, TX (US); Tom Shepard, Austin, TX (US)

(21) Appl. No.: 14/513,554

(22) Filed: Oct. 14, 2014

Related U.S. Application Data
(60) Provisional application No. 61/890,699, filed on Oct. 14, 2013.

(51) Int. Cl. G10L 15/26; H04M 3/487; H04M 3/56

(52) U.S. Cl. CPC G10L 15/26; H04M 3/568; H04M 3/4872
USPC 704/235

(57) ABSTRACT

A system and method include processing multiple individual participant speech in a conference call with an audio speech recognition system to create a transcript for each participant, assembling the transcripts into a single transcript having participant identification for each speaker in the single transcript, and making the transcript searchable. In one embodiment, encoder states are dynamically tracked and the state of each encoder is continuously tracked to allow interchange of state between encoders without creating audio artifacts, and re-initializing an encoder during a brief period of natural silence for encoders whose states continuously diverge. In yet a further embodiment, tracking of how each of multiple users has joined a conference call is performed to determine and utilize different messaging mechanisms for users.

### RELATED APPLICATION

This application claims priority to U.S. Provisional Application Ser. No. 61/890,699 (entitled Conference Transcription System and Method, filed Oct. 14, 2013) which is incorporated herein by reference.

### FIELD

The present invention relates to network based conferencing and digital communications wherein two or more participants are able to communicate with each other simultaneously using Voice over IP (VoIP) with a computer, a telephone, and/or text messaging, while the conversation is transcribed and archived as readable text. Unified communications which integrate multiple modes of communication into a single platform have become an integral part of the modern business environment. Audio portions of such communications, while sometimes recorded, often remain inaccessible to the users of such a platform or fail to integrate effectively with other modes of communication such as text messaging. The present invention seeks to correct this situation by seamlessly integrating audio and text communications through the use of real-time transcription. Further the present invention organizes the audio data into a searchable format using the transcribed text of the conversation as search queues to retrieve relevant portions of the audio conversation and present them to the end user. This allows important information to be recovered from audio conversations automatically and provided to users in the form of business intelligence as well alerting users when relevant information is detected during a live conversation.

### BACKGROUND

Unified communications which integrate multiple modes of communication into a single platform have become an integral part of the modern business environment. Audio portions of such communications, while sometimes recorded, often remain inaccessible to the users of such a platform.

Voice over IP (VOIP) conferencing is generally utilizes either a server-side mix, or a client-side mix. The advantage of a client side mix is that the most computationally expensive part of the process, the compression and decompression (called encoding or decoding) are accomplished at the client. The server merely acts as a relay, rebroadcasting all incoming packets to the other participants in the conference.

The advantage of a server side mix is the ability to dynamically fine-tune the audio from a centralized location, apply effects and mix in additional audio, and give the highest performance experience to the end user running the client (both in terms of network bandwidth and computational expense). In this case, all audio packets are separately decoded at the server, mixed with the audio of the other participants, and separately encoded and transmitted back to the clients. The server side mix incurs a much higher computational expense at the server in exchange extra audio flexibility and simplicity at the client.

For the case of the server side mix, an optimization is possible that takes advantage of the fact that for a significant portion of time most listeners in a conference are receiving the same audio. In this case, the encoding is done only once and copies of the result are broadcast to each listener.

For some modern codecs, particularly the Opus codec, the encoders and decoders are stateful. This means that the result obtained by encoding a packet of audio will vary, based on the contents of packets previously encoded. So, even if two clients are to receive the same audio, that audio must be encoded specifically for each client since they will not understand encoded packets intended for other clients.

### SUMMARY

A system and method include processing multiple individual participant speech in a conference call with an audio speech recognition system to create a transcript for each participant, assembling the transcripts into a single transcript having participant identification for each speaker in the single transcript, and making the transcript searchable.

In one embodiment, a system and method include dynamically tracking encoder states outside of a plurality of encoders, continuously evaluating states of encoders along a number of key metrics to determine which states are converging enough to allow interchange of state between encoders without creating audio artifacts, and re-initializing an encoder during a brief period of natural silence for encoders whose states continuously diverge, despite receiving identical audio for a time, wherein the encoders are stateful such that a result obtained by encoding a packet of audio will vary, based on the contents of packets previously encoded.

A system and method include tracking how each of multiple users has joined a conference call, receiving a message to be communicated to multiple users joined to the conference call, determining a messaging mechanism for each user based on how the user has joined the conference call, formatting the message for communication via the determined messaging mechanisms, and sending the message via the determined messaging mechanism such that each user receives the message based on how the user has joined the conference call.

### BRIEF DESCRIPTION OF THE DRAWINGS

FIG. 1 is a block flow diagram illustrating multiple people exchanging voice communications according to an example embodiment.

FIG. 2 is a block diagram illustrating a system to provide near real-time transcription of conference calls according to an example embodiment.

FIG. 3 is a flowchart illustrating a method of handling stateful encoders in a voice communication system according to an example embodiment.

FIG. 4 is a flowchart illustrating a method of creating a transcript for a voice call according to an example embodiment.

FIG. 5 is a flowchart illustrating a method of generating a transcript from an audio stream according to an example embodiment.

FIG. 6 is a flowchart illustrating a method of obtaining an accurate transcription of an audio stream according to an example embodiment.

FIG. 7 is a flowchart illustrating a method of detecting compliance violations from a transcript according to an example embodiment.

FIG. 8 is a flowchart illustrating a method of converting and exporting transcription data to business intelligence systems according to an example embodiment.

FIG. 9 is a block schematic diagram of a computer system to implement one or more methods and systems according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

Glossary:

Voice over IP: Voice over IP is a mode of digital communications in which voice audio is captured, converted to digital data, transmitted over a digital network using Internet Protocol (IP), converted back to audio and played back to the recipient.

Internet Protocol (IP): Internet Protocol (IP) is a method for transmitting data over a digital network to a specific recipient using a digital address and routing.

Mixed communications, (voice, text, phone, web): Mixed communications are interactive communications using a combination of different modalities such as voice over IP, text, and images and may include a combination of different devices such as web browsers, telephones, SMS messaging, and text chat.

Text messaging: Text messaging is method of two way digital communication in which messages are constructed as text in digital format by means of a keyboard or other text entry device and relayed back and forth by means of Internet Protocol between two or more participants.

Web conference: A web conference is a mixed communication between two or more participants by means of web browsers connected to the internet. Modes of communication may include, but are not limited to voice, video, images, and text chat.

Automatic speech recognition, (ASR): Automatic speech recognition, (ASR), is the process of capturing the audio of a person speaking and converting it to an equivalent text representation automatically by means of a computing device.

Transcription: Transcription is the process of converting a verbal conversation between two or more participants into an equivalent text representation that captures the exchanges between the different participants in sequential or temporal order.

Indexing audio to text: Indexing audio to text is the process of linking segments of recorded audio to text based elements so that the audio can be accessed by means of text-based search processes.

Text based audio search: A text based audio search is the process of searching a body of stored audio recordings by means of a collection of words or phrases entered as text using a keyboard or other text entry device.

Statistical language model: A statistical language model is a collection of data and mathematical equations describing the probabilities of various combinations of words and phrases occurring within a representative sample of text or spoken examples from the language as a whole.

Digital Audio filter: An audio filter is an algorithmic or mathematical transformation of a digitized audio sample performed by a computer to alter specific characteristics of the audio.

Partial homophone: The partial homophone of a word is another word that contains some, but not all of the sounds present in the word.

Phoneme/phonetic: Phonemes are simple speech sounds that when combined in different ways are able to produce the complete sound of any spoken word in a given language.

Confidence score: A confidence score for a word is a numerical estimate produced during automatic speech recognition which indicates the certainty with which the specified word was chosen from among all alternatives.

Contact info: Contact information generally refers to a person's name, address, phone number, e-mail address, or other information that may be used to later contact that person.

Keywords: Keywords are words selected from a body of text which best represent the meaning and contents of the body of text as a whole.

Business intelligence, (BI), tool: A business intelligence tool is a software application that is used to collect and collate information that is useful in the conduct of business.

CODEC, (acronym for coder/decoder): A CODEC is an encoder and decoder pair that is used to transform audio and/or video data into a smaller or more robust form for digital transmission or storage.

Metadata: Metadata is data, usually of another form or type, which accompanies a specified data item or collection. The metadata for an audio clip representing an utterance made during a conference call might include the speaker's name, the time that the audio was recorded, the conference name or identifier, and other accompanying information that is not part of the audio itself.

Mix down, mixed down: The act or product of combining multiple independent audio streams into a single audio stream. For example, taking audio representing input from each participant in a conference call and adding the audio streams together with the appropriate temporal alignment to produce a single audio stream containing all of the voices of the conference call participants.

Various embodiments of the present invention seamlessly integrate audio and text communications through the use of real-time transcription. Audio data may be organized into a searchable format using the transcribed text of the conversation as search queues to retrieve relevant portions of the audio conversation and present them to an end user. Such organization and search capabilities allow important information to be recovered from audio conversations automatically and provided to users in the form of business intelligence as well as alerting users when relevant information is detected during a live conversation.

Audio Encoder Instance Sharing

For some modern codecs used in conference calls, particularly the Opus codec, the encoders and decoders are stateful. This means that the result obtained by encoding a packet of audio will vary, based on the contents of packets previously encoded. So, even if two clients are to receive the same audio, that audio must be encoded specifically for each client since they will not understand encoded packets intended for other clients. Encoding for each client creates significant duplicate work for a server, utilizing substantial processing and memory resources.

In various embodiments of the present invention, an apparatus applies optimization to stateful codecs. The encoder states may be dynamically tracked outside of the encoders, and their states continuously evaluated along a number of key metrics to determine which states are converging enough to allow interchange of state between encoders without creating audio artifacts. For states that continuously diverge, despite receiving identical audio for a time, the codec will be re-initialized during a brief period of natural silence.

Different embodiments may provide functions associated with Voice over IP, web conferencing, telecommunications, transcription, recording, archiving and search.

A method for combining the results from multiple speech recognition services to produce a more accurate result. Given an audio stream, the same audio is processed by multiple speech recognition services. Results from each of the speech recognition services are then compared with each other to find the best matching sets of words and phrases among all of the results. Words and phrases that don't match between the different services are then compared in terms of their confidence scores and the start and end times of the words relative to the start of the common audio stream. Confidence scores for each speech recognition service are adjusted so that they have the same relative scale based on the words and phrases that match. Words and phrases are then selected from among the non-matching words and phrases from each speech recognition service such that the selected words have the highest confidence values and are correctly aligned in time with the matching words and phrases to form a new complete recognition result containing the best selections from the results of all speech recognition services.

A method for correcting speech recognition results using phonetic and language data. This method takes the results from a speech recognition service, identifies words that are likely to be erroneous based on confidence scores from the speech recognition service and the context of other words in the speech recognition result weighed by statistical measurements from a large representative sample of text in the same language, (statistical language model). Words in the speech recognition result that have low confidence scores or are statistically unlikely to occur within the context of other words in the speech recognition result are selected for evaluation and correction. Each word so selected is compared phonetically with other words from the same language to identify similar sounding words based on the presence of matching phonemes, (speech sounds), and non-matching phonemes weighted by the statistical probability of confusing one for the other. The best matching set of similar sounding words, (partial homophones), is then tested against the same statistical language model used to evaluate the original speech recognition results. The combination of alternative words that sounds most like the words in the original speech recognition result and has the highest statistical probability of occurring in the sampled language is selected as the corrected speech recognition result.

A method for qualitatively evaluating the content of speech recognition results for appropriateness, and compliance with corporate policy and legal regulations, providing immediate feedback to the speaker and/or a supervisor during an active conversation. During a conversation, audio is sent to a speech recognition service to be transcribed. The results of this transcription are then evaluated along several dimensions, including clarity, tone, energy, and dominance based on the combinations of words spoken. Additionally, the transcription results are compared against rules representing corporate policy and/or legal regulations governing communications of a sensitive nature. Results of these analyses are then presented to the speaker on a computer display, along with the transcription result, notifying the speaker of any possible transgressions or concerns and allowing the speaker or supervisor to respond appropriately during the course of the conversation. These results are also stored for future use and may be displayed as part of the search and replay of audio and transcription results.

A method for converting and exporting transcription data to business intelligence applications. Audio from a conversation such as a business or sales call is sent to a speech recognition service to be transcribed. The results of this transcription are tagged with contact information that uniquely identifies the participants along with specific information about the call itself, such as time, duration, transfer records, and any information related to the call that is entered into a computer, such as data recorded by a call center representative. Transcript data, as well as data extracted from the transcript, such as relevant customer information, contact information, specific keywords, names, etc. are selected. The audio is indexed to the selected text so that it can be searched and played back using the associated text. Collectively, these data are formatted and submitted to a BI system to be stored and cataloged along with information entered by computer. The result is information in the BI system which allows the call and its associated audio to be searched and accessed seamlessly by an operator using the BI system. This provides seamless integration of audio data into an existing business intelligence infrastructure.

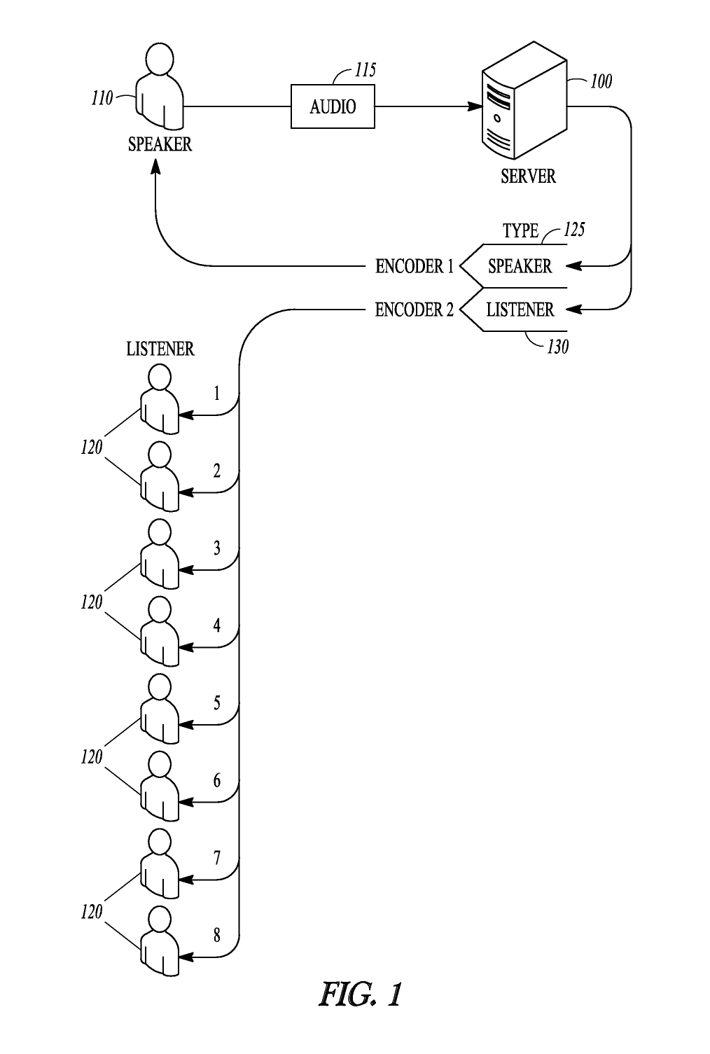

FIG. 1 illustrates an audio mixing server 100 with encoder instance sharing on a stateful codec. A speaker 110 on a call, such as a conference call provides an audio stream 115 to the server 100. The audio may be analog or digital in various embodiments dependent upon the equipment and network used to capture and transmit the audio 115. The speaker may be using a digital or analog land line, cellular phone, network connection via a computer, or other means of capturing and transmitting audio 115 to the server 100. Server 100 creates two versions of the audio stream, one with the speaker 110 and one without.

There may be one or many listeners indicated at 120. Each listener 120 may also take the role of the speaker 110 in further embodiments. In one embodiment, only two parties are communicating back and forth, having a normal conversation, with each switching roles when speaking and alternatively listening. In some embodiments, both parties may speak at the same time, with the server 100 receiving both audio streams, and mixing them.

A speaker encoder 125 encodes and decodes speech in the audio stream for speaker 110. A listener encoder 130 does the same for multiple listeners.

In one embodiment, the server detects that it is about to perform duplicate work, and mergers encoder work into one activity, saving processing time and memory. The use of stateful codecs enables such merging.

Audio Segment of Conference Call

In one embodiment, the server 100 implements a method for processing individual participants in a conference call by an automatic speech recognition (ASR) system, and then displaying them back to the user in near real-time. The method also allows for non-linear processing of each meeting, participant, or individual utterance; and then reassembling the transcript for display. The method also facilitates synchronized audio playback for individual participants with their transcript or all participants when reviewing an archive of a conference.

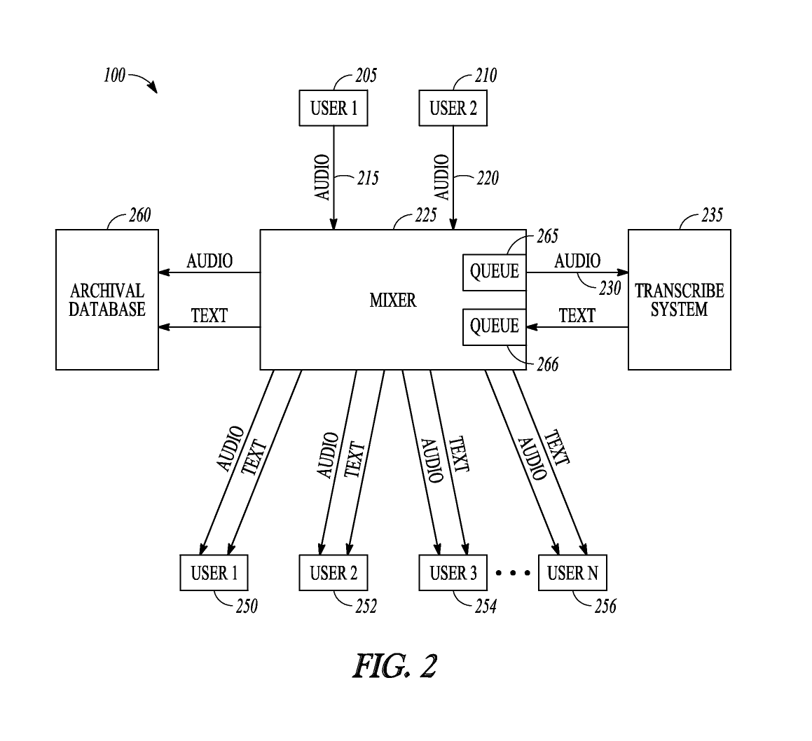

In one embodiment, a system 200 illustrated in block form in FIG. 2 provides near real-time transcription of conference calls for display to participants. Real-time processing and automated notifications may also be provided to participants who are or are not present on the call. System 200 allows participants to search prior conference calls for specific topics or keywords. And allows audio from a conference call to be played back with synchronized transcript for individual, groups, or all participants.

Real-time transcription serves at least two purposes. Speaker identification is one. The transcript is annotated with speaker identification and correlated to the actual audio recording so that words in the transcript are correlated or linked to audio playtime and may be selectively played back.

In one example, there may be 60 minutes of a speaker named Spence talking. It's great that you know its Spence, but what's even more useful is finding the 15 second sound bite of Spence talking that you care about. That ability is one benefit provided in various embodiments. The transcript provides information identifying what words were spoken during N seconds of audio. And when the user is looking for that specific clip, it can be found. A playback cursor and transcript cursor may be moved to that position, and audio played back to the user.

System 200 shows two users, 205 and 210 speaking, with respective audio streams 215, 220 being provided to a coupled mixer system 225. When a user or participant speaks, their voice may be captured as a unique audio stream which is sent to the mixer 225 for processing. In one embodiment, mixer 225, also referred to as an audio server, records the speaker of each audio stream separately, applying a timestamp, along with other metadata, and forwards the audio stream for transcription. Because each speaker has a discrete audio channel, over-talking is accommodated.

Mixer 225 provides the audio via an audio connection 230 to a transcriber system 235, which may be a networked device, or even a part of mixer 225 in some embodiments. The audio may be tagged with information identifying the speaker corresponding to each audio stream. The transcriber system 235 provides a text based transcript on a text connection 240 to the mixer 225. In one embodiment, the speaker's voice is transcribed in near-real time via a third party transcription server. Transcription time reference and audio time references are synchronized. Audio is mixed and forwarded in real time, which means the audio is mixed and forwarded as processed with little if any perceivable delay by a listening user or participant in a call. Near real time is a term used with reference to the transcript, which follows the audio asynchronously as it becomes available. A 10-15 second delay may be encountered, but that time is expected to drop as network and processing speeds increase, and as speech recognition algorithms become faster. It is anticipated that near real time will progress toward a few seconds to sub second response times in the future. Rather than storing and archiving the transcripts for later review by participants and others, providing the transcripts in near real time allows for real time searching and use of the transcripts while participating in the call, as well as alerting functions described below.

An example annotated transcript of a conference call between three different people, referred to as User 1, User 2, and User 3 may take a form along the following example:
User 1 Sep. 27, 2014 12:48:03-12:48:06 “The server implementation at the new site is going well.”
User 1 Sep. 27, 2014 12:48:09-12:48:15 “Assuming everything else follows the plan, we'll be done on time this Friday.”
User 2 Sep. 27, 2014 12:48:14-12:48:19 “Glad to hear you're work stream is on time Alex.”
User 3 Sep. 27, 2014 12:48:19-12:48:26 “Alex how does your status update mean about how we're doing on budget?”
User 3 Sep. 27, 2014 12:48:27-12:48:32 “Is it safe to assume we're on track to the $50,000 dollars you shared last week?”
User 2 Sep. 27, 2014 12:48:32-12:48:40 “Before we talk budgets Wendy lets hear from the other program leads.”

Each user is recorded on a different channel and the annotated transcript may include an identifier of the user, a date, a time range, and corresponding text of the speech in the recorded channel. Note that in some entries, a user may speak twice. Each channel may be divided into logical units, such as sentences. This may be done based on delay between speech of each sentence, or on a semantic analysis of the text to identify separate sentences.

The mixer 225 may then provide audio and optionally text to multiple users indicated at 250, 252, 254, 256 as well as to an archival system 260. The audio recording may be correlated to the annotated transcript for playback, and links may be provided between the transcript and audio to navigate to the corresponding points in both. Note that users 250 and 252 may correspond to the original speakers 205 and 210, and are shown separately in the figure for clarity, as a user may utilize a telephone for voice and a computer for display of text. A smart phone, tablet, laptop computer, desktop computer or terminal may also be used for either or both voice and data in some embodiments. A small application may be installed to facilitate presentation of voice and data to the user as well as providing an interface to perform functions on the data comprising the transcript. In further embodiments, there may be more than two speakers, or there may be only two parties on the call. The multiple text and audio connections shown may be digital or analog in various embodiments, and may be hardwired or wireless connections.

The channel mixed automatic speech recognition (ASR) system provides speaker identification, making it much easier to follow a conversation occurring during a conference call. In one embodiment, the speaker is identified by correlating phone number and email address. The transcript as shown in the above example, in addition to identifying the speaker indicates the date and time of the speech for each speaker. Adding the date and time to recorded speech information provides a more robust ability to search the transcript by various combinations of speaker, date, and time.

In one embodiment, the system implements a technique of associating speech recognition results to the correct speaker in a multi-user audio interaction. A mixing audio server captures and mixes each speaker as an individual audio stream. When a user speaks that user's audio is captured as a unique instance. That unique audio instance is then transcribed to text using ASR and then paired with the speaker's identification (among other things) from the channel audio capture. The resulting output is a transcript of an individual speaker's voice. This technology scales to an unlimited number of users and even works when users speak over one another. When applied in the context of a conference call, for instance, an automatic transcript of the call with speaker attribution is achieved.

Each of the individual participant's utterances from the mixing audio server, containing the metadata about the participant and the time the utterance started, are placed into two first in first out (FIFO) queues 265, 266. The ASR will then pull the audio from the first queue, transcribing the utterances, and places the result along with any metadata that was with the audio on another FIFO queue where it will be sent to any participant who is subscribed to the real-time feed; it is also stored into the database 260 for on-demand retrieval and indexing. The audio from the second FIFO queue may be persisted to storage media along with the metadata for each utterance. At the end of the meeting, all the audio from each participant may be mixed down and encoded for playback. Live meeting transcriptions facilitate the ability to search, bookmark, and share calls with many applications.

By using the timestamp and a unique id for each participant stored in the metadata with the audio and the transcription we can synchronize each participant's transcription as the audio is played back, and allow for the transcription to be searched allowing for not only the transaction to be returned in the search result, but the individual utterance as well.

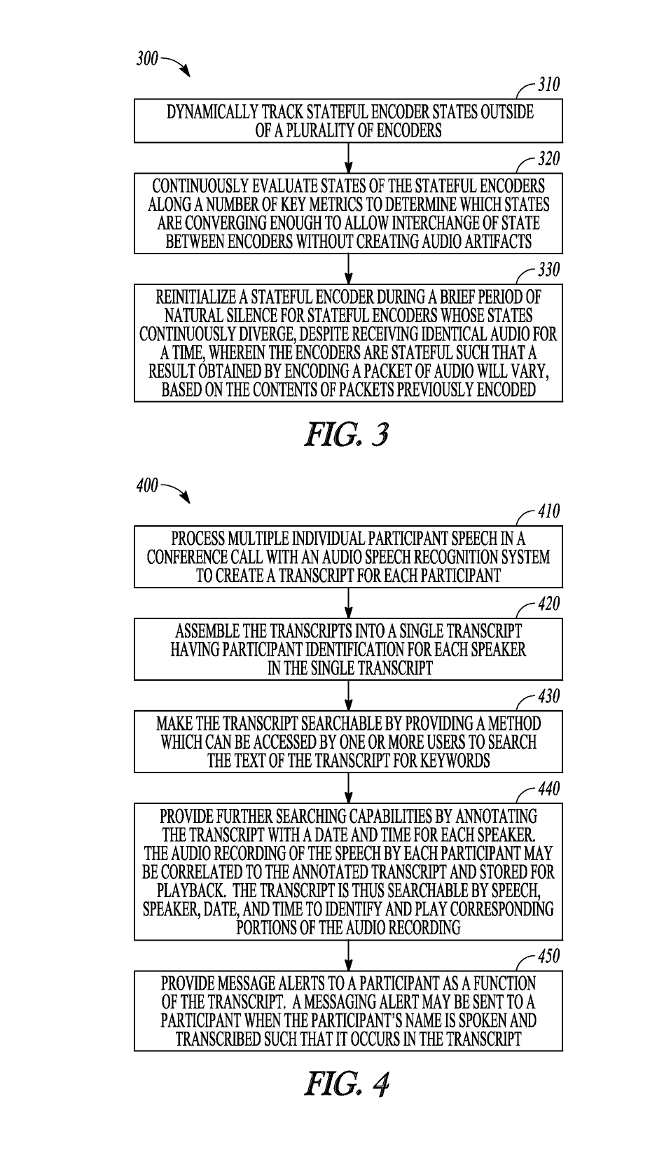

FIG. 3 is a flowchart illustrating a method 300 of handling stateful encoders in a voice communication system according to an example embodiment. At 310, stateful encoder states are dynamically tracked outside of a plurality of encoders. The states of the stateful encoders are continuously evaluated at 320 along a number of key metrics to determine which states are converging enough to allow interchange of state between encoders without creating audio artifacts. At 330, a stateful encoder is reinitialized during a brief period of natural silence for stateful encoders whose states continuously diverge, despite receiving identical audio for a time, wherein the encoders are stateful such that a result obtained by encoding a packet of audio will vary, based on the contents of packets previously encoded.

FIG. 4 is a flowchart illustrating a method 400 of creating a transcript for a voice call. Method 400 processes multiple individual participant speech in a conference call at 410 with an audio speech recognition system to create a transcript for each participant. The transcripts are assembled at 420 into a single transcript having participant identification for each speaker in the single transcript. At 430, the transcript is made searchable by providing a method which can be accessed by one or more users to search the text of the transcript for keywords. Further searching capabilities are provided at 440 by annotating the transcript with a date and time for each speaker. The audio recording of the speech by each participant may be correlated to the annotated transcript and stored for playback. The transcript is thus searchable by speech, speaker, date, and time to identify and play corresponding portions of the audio recording.

At 450, messaging alerts may be provided to a participant as a function of the transcript. A messaging alert may be sent to a participant when the participant's name is spoken and transcribed such that it occurs in the transcript. A user interface may be provided to the user to facilitate searching, such as filtering by user or matching transcript text to specified search criteria. In one embodiment, an alert to a user may be generated when that user's name appears in the transcript. The user is thus alerted, and can quickly review the transcript to see the context in which their name was used. The user in various embodiments may already be on the call, may have been invited to join the call, but had not yet joined, or may be monitoring multiple calls if in possession of proper permissions to do so. Further alerts may be provided based on topic alerts, such as when a topic begins, or on the occurrence of any other text that meets a specified search criteria.

Search strings may utilize Boolean operators or natural language query in various embodiments, or may utilize third party search engines. The searching may be done while the transcript is being added to during the meeting and may be periodically or continuously applied against new text as the transcript is generated. In one embodiment, continuously applied search criteria includes searching each time a logical unit of speech by a speaker is generated, such as a word or sentence. A user may scroll forward or backward in time to view surrounding text, and the text meeting the search criteria may have a visible attribute to call attention to it, such as highlighting or bolding of the text.

Transcripts of prior meetings may be stored in a meeting library and may also be searched in various embodiments. The meeting library may contain a list of meetings previously invited to, and indicate a status for the meeting, such as missed, received, attended, etc. The library links to the transcript and audio recording. The library may also contain a list of upcoming meetings, providing a subject, attendees, time, and date, as well as a join meeting button to join a meeting starting soon or already in process.

In one embodiment, a search option screen may be provided with a field to enter search terms, and checkboxes for whether or not to include various metadata in the search, such as meeting name, topics, participants, files, bookmarks, transcript, etc.

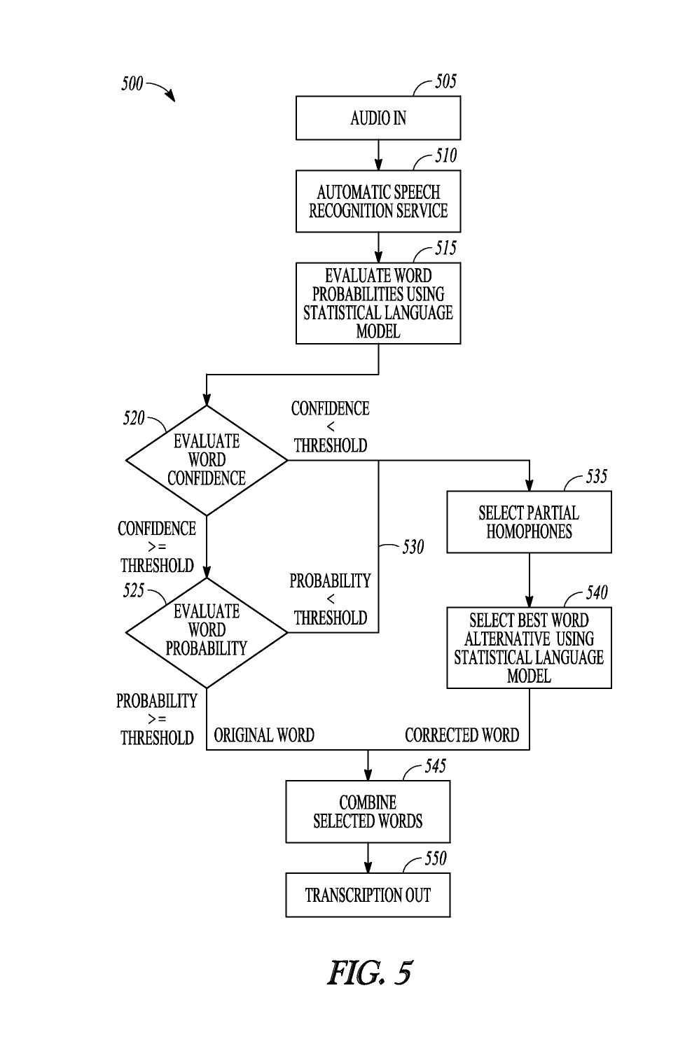

FIG. 5 is a flowchart illustrating a method 500 of generating a transcript from an audio stream 505 according to an example embodiment. As previously indicated, the audio stream 505 may contain multiple channels of audio in one embodiment, each channel corresponding to a particular caller, also referred to as a speaker or user. The audio is provided to an automatic speech recognition service or services at 510, which provides word probabilities. The word probabilities are evaluated at 515 using a statistical language model. The confidence in each word is evaluated at 520, and if the confidence is greater than or equal to a selected confidence threshold, the word probability is evaluated at 525 to determine if the probability is also greater than or equal to a selected probability threshold. If either the confidence is less than the confidence threshold at 520 or the probability is less than the probability threshold at 525, a partial homophone is selected at 535 and a best word alternative using the statistical language model at 540 is selected to provide a corrected word. At 545, selected words, either the corrected word or the original word from a successful probability evaluation at 525 are combined at 545 to produce the transcript 550 as output.

A method for correcting speech recognition results using phonetic and language data. This method takes the results from a speech recognition service, identifies words that are likely to be erroneous based on confidence scores from the speech recognition service and the context of other words in the speech recognition result weighed by statistical measurements from a large representative sample of text in the same language, (statistical language model). Words in the speech recognition result that have low confidence scores or are statistically unlikely to occur within the context of other words in the speech recognition result are selected for evaluation and correction. Each word so selected is compared phonetically with other words from the same language to identify similar sounding words based on the presence of matching phonemes, (speech sounds), and non-matching phonemes weighted by the statistical probability of confusing one for the other. The best matching set of similar sounding words, (partial homophones), is then tested against the same statistical language model used to evaluate the original speech recognition results. The combination of alternative words that sounds most like the words in the original speech recognition result and has the highest statistical probability of occurring in the sampled language is selected as the corrected speech recognition result.

Method 500 provides correct speech recognition results using phonetic and language data. The results from a speech recognition service are obtained and used to identify words that are likely to be erroneous based on confidence scores from the speech recognition service and the context of other words in the speech recognition result weighed by statistical measurements from a large representative sample of text in the same language, referred to as a statistical language model. Words in the speech recognition result that have low confidence scores or are statistically unlikely to occur within the context of other words in the speech recognition result are selected for evaluation and correction. Each word so selected is compared phonetically with other words from the same language to identify similar sounding words based on the presence of matching phonemes, (speech sounds), and non-matching phonemes weighted by the statistical probability of confusing one for the other. The best matching set of similar sounding words, (partial homophones), is then tested against the same statistical language model used to evaluate the original speech recognition results. The combination of alternative words that sounds most like the words in the original speech recognition result and has the highest statistical probability of occurring in the sampled language is selected as the corrected speech recognition result.

Further examples and description of method 500 are now provided. Given the utterance, “To be or not to be, that is the question.” Perhaps a resulting transcription is, “To be or not to be, that is the equestrian.” If the words and confidence values returned from the transcription service are as follows: To (0.9), be (0.87), or (0.99), not (0.95), to (0.9), be (0.85), that (0.89), is (0.88), the (0.79), equestrian (0.45), then the word “equestrian” is selected as a possible error based on its confidence score being lower than a target threshold, (0.5 for example). Next, the word “equestrian” is decomposed into its constituent phonemes: equestrian->IH K W EH S T R IY AH N through the use of a phonetic dictionary or through the use of pronunciation rules.

The phonetic representation is then compared with other words in the phonetic dictionary to find the best matches based on a phonetic comparison:

| | |
|---|---|
| mention | M EH N SH AH N |
| question | K W EH S CH AH N |
| suggestion | S AH G JH EH S CH AH N |
| digestion | D AY JH EH S CH AH N |
| election | IH L EH K SH AH N |
| samaritan | S AH M EH R IH T AH N |

The phonetic comparison takes into account the likelihood of confusing one phoneme for another. Let Pc(a, b) represent the probability of confusion phoneme ‘a’ with phoneme ‘b’. When comparing the phonemes making up different words, the phonemes are weighted by their confusion probability Pc( )

As a hypothetical example:
Pc(T, T)=1.0
Pc(T, CH)=0.25
Pc(JH, CH)=0.23
Pc(EH, AH)=0.2
Pc(IH, EH)=0.1

This allows words composed of different phonemes to be directly compared in terms of how similar they sound and how likely they are to be mistaken for one another. For each low confidence word in the transcribed utterance, a set of the most similar sounding words is selected from the phonetic dictionary.

These words, both alone and in combination, are then evaluated for how likely the resulting phrase is to occur in the given language based on statistical measures taken from a representative sample of the language. Each word in an utterance has a unique probability of occurring in the same utterance as any other word in the language. Let Pl(a, b) represent the probability of words ‘a’ and ‘b’ occurring in the same utterance in language ‘l’. Each word in the selected set of homophones has a specific probability of occurring with each other word in the utterance. As a hypothetical example:
Pl(“to”, “equestrian”)=0.1
Pl(“be”, “equestrian”)=0.08
Pl(“or”, “equestrian”)=0.05
Pl(“to”, “question”)=0.12
Pl(“be”, “question”)=0.1
Pl(“or”, “question”)=0.07

Likewise there are similar probabilities associated with any given word occurring in the same utterance as a combination of other words. Let Pl(a b, c) represent the probability of both words ‘a’ and ‘b’ occurring in the same utterance with word ‘c’, Pl(a b c, d) is the probability of words ‘a″b’ and ‘c’ occurring in the same utterance with word ‘d’, and so on. To continue the previous hypothetical example:
Pl(“to be”, “equestrian”)=0.005
Pl(“or not”, “equestrian”)=0.002
Pl(“to be”, “question”)=0.08
Pl(“or not”, “question”)=0.07

Taken together, these probabilities predict the likelihood of any given word occurring in any specified utterance based on the statistical attributes of the language. For a perfect language model, the probabilities for every word in every utterance in the language would be exactly equal to the measured frequency of occurrence within the language. In the case of our example, “To be, or not to be, that is the question” is a direct quote from William Shakespeare's ‘Hamlet’ or a paraphrase or reference to it. Thus, given the utterance “To be, or not to be, that is the ______”, the word ‘question’, should have the highest probability of occurring of any word in the language, and should therefore be chosen from the set of partial homophones. Words, so selected based on their statistical probability of co-occurrence within a given utterance replace the low confidence words and produce a corrected and more accurate transcription result.

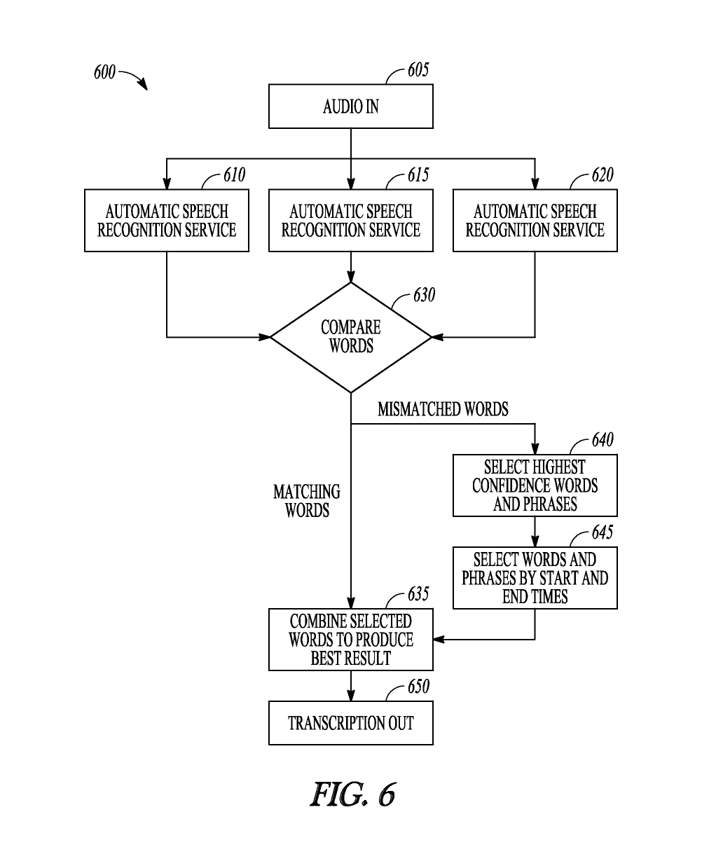

FIG. 6 is a flowchart illustrating a method 600 of obtaining an accurate transcription of an audio stream indicated at 605. In one embodiment, multiple automatic speech recognition services 610, 615, and 620 for example, are provided the audio stream 605. For each uttered word, or what each service identifies as a word, the word is identified by the respective services and compared at 630. The words may be correlated based on time stamps and channel corresponding to a user in one embodiment to ensure each service is processing the same utterance. If at 630 the compared words match, the word is combined with previous words at 635. If there are mismatched words resulting from the services 610, 615, 620, the mismatched words are provided to element 640 where the highest confidence words, or phrases are selected. The selected words and phrases are then selected as a function of the start and end times at 645, and provided to element 635 for combining Note that at 645, a phrase may be selected from one of the services, along with one or more words from different services to arrive at a more accurate combination of words and phrases for a given time interval. A transcript is then provided at 650 from the combining element 635.

Method 600 combines the results from multiple speech recognition services to produce a more accurate result. Given an audio stream consisting of multiple user correlated channels, the same audio is processed by multiple speech recognition services. Results from each of the speech recognition services are then compared with each other to find the best matching sets of words and phrases among all of the results. Words and phrases that don't match between the different services are then compared in terms of their confidence scores and the start and end times of the words relative to the start of the common audio stream. Confidence scores for each speech recognition service are adjusted so that they have the same relative scale based on the words and phrases that match. Words and phrases are then selected from among the non-matching words and phrases from each speech recognition service such that the selected words have the highest confidence values and are correctly aligned in time with the matching words and phrases to form a new complete recognition result containing the best selections from the results of all speech recognition services. A single, more accurate recognition result is obtained by combining elements selected from each of the speech recognition services, providing a highly accurate transcription of the speaker.

Method 600 uses the context of the utterance itself and the statistical properties of the entire language to help disambiguate individual words to produce a better recognition result.

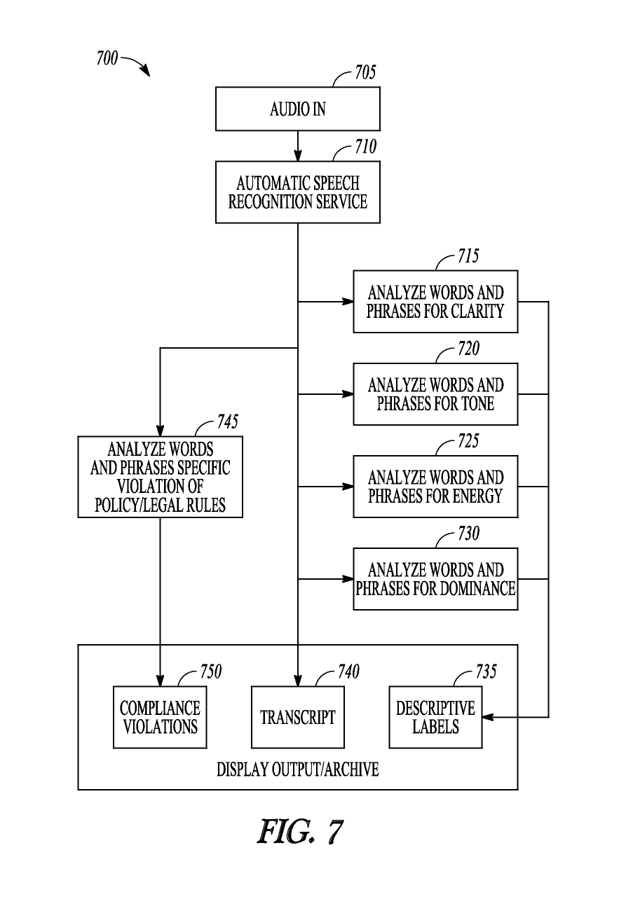

FIG. 7 is a flowchart illustrating a method 700 of detecting compliance violations utilizing speech recognition of calls. Audio is provided at 705, and may comprise a separate audio channel correlated to each of multiple speakers. The audio is provided to an automatic speech recognition service 710 which produces text corresponding to utterances in the audio. Analysis of the text is provided at several different levels as indicated at 715, 20, 725, and 730. Words and phrases may be analyzed for clarity at 715, analyzed for tone at 720, for energy at 725, and for dominance qualities at 730. At 735, the analysis of each of these elements is provided a descriptive label at 735 and correlated with a transcript 740 resulting from the speech recognition service 710. An additional analysis element 745 also receives the text from service 710 and analyzes the words and phrases for specific violation of policies and legal rules governing conduct. Compliance violations are identified and logged at 750. In one embodiment, violations may be detected simply as a matter of detecting certain words in the transcript. The words may be taken directly from the policy, or derived from the policy by a person responsible for enforcement of the policy and used in a search string to be applied against the transcript. More advanced implementations may also be used to detect phrases and utterances that include improper communications via a qualitative semantic analysis, similar to that used to detect the speech metric dimensions.

The violations may also be correlated with the transcript and channel of the audio, and hence also identifying the user uttering such words and phrases. The violations may be made visible via display or by searching archives. In some instances, a supervisor or the legal or compliance groups within an entity, such as a company may be automatically notified of such violations via email or other communication. The notification may also include a citation to a policy, and may include text of the policy corresponding to the detected violation. In further embodiments, a percentage probability and/or confidence or other rating may be given to the detected violation and provided in the notification.

Method 700 qualitatively evaluates the content of speech recognition results for appropriateness, and compliance with corporate policy and legal regulations, providing immediate feedback to the speaker and/or a supervisor during an active conversation. During a conversation, audio is sent to a speech recognition service to be transcribed. The results of this transcription are then evaluated along several dimensions, including clarity, tone, energy, and dominance based on the combinations of words spoken. These dimensions may be referred to as a speech metrics. In one embodiment, WordSentry® software is used to provide a measure of such dimensions, such as speech metrics on a scale of 0-1, with 1.0 being higher clarity, better tone, more energy, and more dominant or direct and 0.5 being neutral. Additionally, the transcription results are compared against rules representing corporate policy and/or legal regulations governing communications of a sensitive nature. Results of these analyses are then presented to the speaker on a computer display, along with the transcription result, notifying the speaker of any possible transgressions or concerns and allowing the speaker or supervisor to respond appropriately during the course of the conversation. These results are also stored for future use and may be displayed as part of the search and replay of audio and transcription results.

For clarity, a low precision statement would result in a low measure of clarity, such as 1: “I′m going to get something to clean the floor.” A higher measure would result from an utterance like: “I′m going to use the sponge mop to clean the floor with ammonia at 2 PM.”

For tone, the metric is a measure of the negativity, with 0 being very negative or depressing, and 1 bordering on positivity or exuberance. While tone can take on many other emotions, such as scared, anxious, excited, and worried for example, it may be used primarily as a measure of negativity in one embodiment.

Energy is a measure of the emotionally evocative nature of an utterance. It may be adjective heavy. A high energy example may include an utterance including words like great, fantastic, etc. “Its Ok” would be a low energy utterance.

Dominance—Indirect to direct. “It would be nice if you did this.” vs “I order you to do this.”

Additional dimensions may be added in further embodiments.

The following are additional examples for method 700, referred to as conversation analysis. Conversation analysis for sentiment and compliance is carried out using the WordSentry® product.

The operating principle of this system is a mathematical model based on the subjective ratings of various words and phrases along several qualitative dimensions. Dimensions used include clarity, tone, energy, and dominance. The definitions and examples of each of these qualitative categories are as follows: Clarity, range 0 to 1: The level of specificity and completeness of information in an utterance or conversation.

In one clarity example:
Clarity=0.1
“I'm going to get something to clean with.”
Clarity=0.5
“I'm going to buy a vacuum cleaner to clean the floors.”
Clarity=1.0
“I'm going to buy a Hoover model 700 vacuum cleaner from Target tomorrow to clean the carpets in my house.”

Tone is also represented as a range of 0 to 1, and corresponds to the positive or negative emotional connotation of an utterance or conversation. An example of tone includes:
Tone=0.1
“I hate my new vacuum and wish the people who made it would drop dead!”
Tone=0.5
“My new vacuum cleaner is adequate and the people who made it did a decent job.”
Tone=1.0
“I love my new vacuum and I could just hug the people who made it!”

Energy includes the ability of an utterance or conversation to create excitement and motivate a person. One example of energy includes:
Energy=0.1
“This vacuum is nice.”
Energy=0.5
“This vacuum is very powerful and will make cleaning your carpets much easier.”
Energy=1.0
“This vacuum is the most powerful floor cleaning solution ever made and you will absolutely love using it!”

Dominance includes the degree of superiority or authority represented in an utterance or conversation. One example of dominance includes:
Dominance=0.1
“It would be nice if you got a vacuum cleaner.”
Dominance=0.5
“I want you to get a vacuum cleaner.”
Dominance=1.0
“Buy a vacuum cleaner now.”

In addition to analyzing the sentiment of utterances, the system will also screen for specific compliance issues based on corporate policy and legal requirements. These are generally accomplished using heuristics that watch for certain combinations of words, certain types of information, and specific phrases. For example, it is illegal in the financial sector to promise a rate of return on an investment:
Compliant:
“I guarantee I can meet you for lunch today.”
Non-compliant:
“I guarantee at least 10% return on this investment.”

In this case, the use of the word “guarantee” is only a compliance violation when it occurs in the same utterance as a percentage value and the word “return” and/or “investment”.

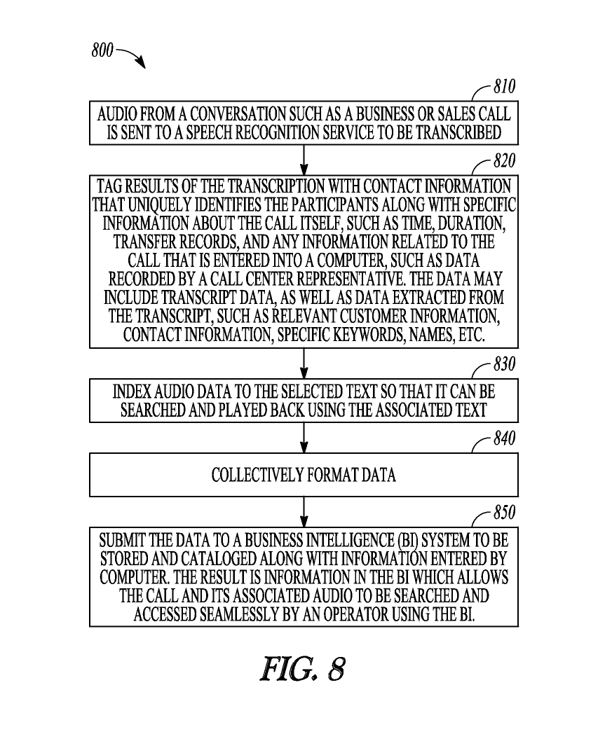

A further method 800 shown in flowchart form in FIG. 8 converts and exports transcription data to business intelligence applications. At 810, audio from a conversation such as a business or sales call is sent to a speech recognition service to be transcribed. The results of this transcription are tagged at 820 with contact information that uniquely identifies the participants along with specific information about the call itself, such as time, duration, transfer records, and any information related to the call that is entered into a computer, such as data recorded by a call center representative. The data may include transcript data, as well as data extracted from the transcript, such as relevant customer information, contact information, specific keywords, names, etc. The audio is indexed to the selected text at 830 so that it can be searched and played back using the associated text. Collectively, these data are formatted at 840 and submitted to a business intelligence (BI) system at 850 to be stored and cataloged along with information entered by computer. The result is information in the BI system which allows the call and its associated audio to be searched and accessed seamlessly by an operator using the BI system. This provides seamless integration of audio data into an existing business intelligence infrastructure.

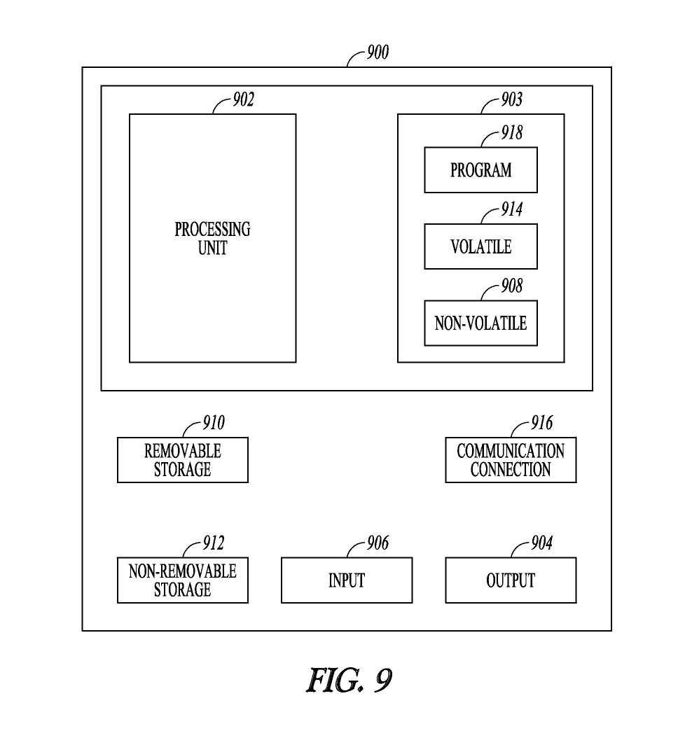

FIG. 9 is a block schematic diagram of a computer system 900 to implement one or more of the methods according to example embodiments. An object-oriented, service-oriented, or other architecture may be used to implement such functions and communicate between the multiple systems and components. One example computing device in the form of a computer 900, may include a processing unit 902, memory 903, removable storage 910, and non-removable storage 912. Memory 903 may include volatile memory 914 and non-volatile memory 908. Computer 900 may include—or have access to a computing environment that includes—a variety of computer-readable media, such as volatile memory 914 and non-volatile memory 908, removable storage 910 and non-removable storage 912. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 900 may include or have access to a computing environment that includes input 906, output 904, and a communication connection 916. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 902 of the computer 900. A hard drive, CD-ROM, and RAM are some examples of articles including a non-transitory computer-readable medium. For example, a computer program 918 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 900 to provide generic access controls in a COM based computer network system having multiple users and servers.

Stateful Encoder Reinitialization Examples

1. A method comprising:

dynamically tracking stateful encoder states outside of a plurality of encoders;

continuously evaluating states of stateful encoders along a number of key metrics to determine which states are converging enough to allow interchange of state between encoders without creating audio artifacts; and

re-initializing a stateful encoder during a brief period of natural silence for stateful encoders whose states continuously diverge, despite receiving identical audio for a time, wherein the encoders are stateful such that a result obtained by encoding a packet of audio will vary, based on the contents of packets previously encoded.

### Annotated Transcript Generator Examples

1. A method comprising:

processing multiple individual participant speech in a conference call with an audio speech recognition system to create a transcript for each participant;

assembling the transcripts into a single transcript having participant identification for each speaker in the single transcript; and

making the transcript searchable.

2. The method of example 1 and further comprising annotating the transcript with a date and time for each speaker.

3. The method of example 2 and further comprising storing an audio recording of the speech by each participant correlated to the annotated transcript for playback.

4. The method of example 3 wherein the transcript is searchable by speech, speaker, date, and time to identify and play corresponding portions of the audio recording.

5. The method of any of examples 1-4 and further comprising providing messaging alerts to a participant as a function of the transcript.

6. The method of example 5 wherein a messaging alert is sent to a participant when the participant's name is spoken and transcribed such that it occurs in the transcript.

7. The method of any of examples 5-6 wherein providing messaging alerts comprises:

identifying a portion of the transcript meeting a search string;

identifying an address corresponding to the search string;

creating a message using the portion of the transcript meeting the search string; and

sending the message to the identified address.

8. The method of example 7 wherein the address comprises an email address.

9. The method of any of examples 7-8 wherein the portion of the transcript contains a name of a person occurring in the identified portion of the transcript, and wherein the identified address corresponds to the person.

10. The method of any of examples 7-9 wherein the portion of the transcript contains keywords included in a search string by person, and wherein the address corresponds to an address of the person.

11. The method of any of examples 5-10 wherein the messages are sent in near real time as the transcript of the conference call is generated during the conference call.

12. The method of any of examples 5-11 wherein the messaging alert points to a portion of the transcript giving rise to the messaging alert such that the portion of the transcript is displayable to the participant receiving the alert.

13. A computer readable storage device having programming stored thereon to cause a computer to perform a method, the method comprising:

processing multiple individual participant speech in a conference call with an audio speech recognition system to create a transcript for each participant;

assembling the transcripts into a single transcript having participant identification for each speaker in the single transcript; and

making the transcript searchable.

14. The computer readable storage device of example 13 wherein the method further comprises:

annotating the transcript with a date and time for each speaker; and

storing an audio recording of the speech by each participant correlated to the annotated transcript for playback, wherein the transcript is searchable by speech, speaker, date, and time to identify and play corresponding portions of the audio recording.

15. The computer readable storage device of any of examples 13-14 wherein the method further comprises providing messaging alerts to a participant as a function of the transcript.

16. The computer readable storage device of any of examples 13-15 wherein the method further comprises sending a messaging alert to a participant when the participant's name is spoken and transcribed such that it occurs in the transcript.

17. The computer readable storage device of any of examples 13-16 wherein providing messaging alerts comprises:

identifying a portion of the transcript meeting a search string;

identifying an address corresponding to the search string;

creating a message using the portion of the transcript meeting the search string; and

sending the message to the identified address.

18. A system comprising:

a mixing server coupled to a network to receive audio streams from multiple users;

an transcription audio output to provide the audio streams to a transcription system;

a data input to receive text from the transcription system corresponding to the audio streams provided to the transcription system;

a transcript generator to receive the text, assemble the text into a single transcript having participant identification for each speaker in the single transcript, and make the transcript searchable; and

user connections to provide the audio and the transcript to multiple users.

19. The system of example 18 and further comprising a transcript database coupled to receive the transcript and archive the transcript in a searchable form.

20. The system of any of examples 18-19 wherein the mixing server further comprises:

a first queue coupled to the transcription audio output from which the transcription system draws audio streams to transcribe; and

a second queue to receive text from the transcription system and meta data associated with utterances in the audio streams correlated to the text.

Semantic Based Speech Transcript Enhancement

1. A method comprising:

receiving multiple original word text representing transcribed speech from an audio stream;

generating word probabilities for the multiple original words in the text via a computer programmed to derive the word probabilities from a statistical language model, including a confidence for the word;

if the confidence or probability for an original word is less than a confidence threshold or probability threshold respectively:
select partial homophones for the word; and
select a best word alternative using a second statistical language model to provide a corrected word; and

combining the corrected word with other corrected words and original words having confidence and probabilities not less than the respective thresholds.

2. The method of example 1 and further comprising generating a transcript from the combined corrected and original words.

3. The method of any of examples 1-2 wherein the first and second statistical language models are the same.

4. The method of any of examples 1-3 wherein a confidence less than the confidence threshold corresponds to an original word being statistically unlikely to occur within the context of other words in the multiple original words of text.

5. The method of any of examples 1-4 wherein selecting partial homophones comprises comparing the word phonetically with other words in the same language to identify similar sounding words based on the presence of matching phonemes and non-matching phonemes weighted by a statistical probability of confusing one for the other.

6. The method of any of examples 1-5 wherein selecting a best word alternative includes:

determining a best matching set of similar sounding words;

testing the best matching set of similar sounding words against the second statistical language model, which is the same as the first statistical language model; and

selecting the word that sounds most like the original word and has the highest statistical probability of occurring in the multiple original word text.

7. The method of any of examples 1-6 wherein selecting partial homophones comprises comparing the word phonetically with other words in the same language to identify similar sounding words based on the presence of matching phonemes and non-matching phonemes weighted by a statistical probability of confusing one for the other, and wherein selecting a best word alternative includes:

determining a best matching set of similar sounding words;

testing the best matching set of similar sounding words against the second statistical language model, which is the same as the first statistical language model; and

selecting the word that sounds most like the original word and has the highest statistical probability of occurring in the multiple original word text.

8. The method of any of examples 1-7 wherein the multiple original word text representing transcribed speech from an audio stream comprises multiple audio streams, each corresponding to speech from a different user.

9. A computer readable storage device having instructions for execution by a computer to cause the computer to perform a method, the method comprising:

receiving multiple original word text representing transcribed speech from an audio stream;

generating word probabilities for the multiple original words in the text via a computer programmed to derive the word probabilities from a statistical language model, including a confidence for the word;

if the confidence or probability for an original word is less than a confidence threshold or probability threshold respectively:
select partial homophones for the word; and
select a best word alternative using a second statistical language model to provide a corrected word; and

combining the corrected word with other corrected words and original words having confidence and probabilities not less than the respective thresholds.

10. The computer readable storage device of example 9 wherein the method further comprises generating a transcript from the combined corrected and original words.

11. The computer readable storage device of any of examples 9-10 wherein a confidence less than the confidence threshold corresponds to an original word being statistically unlikely to occur within the context of other words in the multiple original words of text.

12. The computer readable storage device of any of examples 9-11 wherein selecting partial homophones comprises comparing the word phonetically with other words in the same language to identify similar sounding words based on the presence of matching phonemes and non-matching phonemes weighted by a statistical probability of confusing one for the other.

13. The computer readable storage device of any of examples 9-12 wherein selecting a best word alternative includes:

determining a best matching set of similar sounding words;

testing the best matching set of similar sounding words against the second statistical language model, which is the same as the first statistical language model; and

selecting the word that sounds most like the original word and has the highest statistical probability of occurring in the multiple original word text.

14. The computer readable storage device of any of examples 9-13 wherein selecting partial homophones comprises comparing the word phonetically with other words in the same language to identify similar sounding words based on the presence of matching phonemes and non-matching phonemes weighted by a statistical probability of confusing one for the other, and wherein selecting a best word alternative includes:

determining a best matching set of similar sounding words;

testing the best matching set of similar sounding words against the second statistical language model, which is the same as the first statistical language model; and

selecting the word that sounds most like the original word and has the highest statistical probability of occurring in the multiple original word text.

15. The computer readable storage device of any of examples 9-14 wherein the multiple original word text representing transcribed speech from an audio stream comprises multiple audio streams, each corresponding to speech from a different user.

16. A system comprising:

a processor;

a network connector coupled to the processor; and

a storage device coupled to the processor, the storage device having instructions for execution by the processor to cause the processor to perform a method comprising:
receiving multiple original word text representing transcribed speech from an audio stream;
generating word probabilities for the multiple original words in the text via a computer programmed to derive the word probabilities from a statistical language model, including a confidence for the word;
if the confidence or probability for an original word is less than a confidence threshold or probability threshold respectively:
   select partial homophones for the word; and
   select a best word alternative using a second statistical language model to provide a corrected word; and
combining the corrected word with other corrected words and original words having confidence and probabilities not less than the respective thresholds.

17. The system of example 16 wherein the method further comprises generating a transcript from the combined corrected and original words.

18. The system of any of examples 16-17 wherein a confidence less than the confidence threshold corresponds to an original word being statistically unlikely to occur within the context of other words in the multiple original words of text.

19. The system of any of examples 16-18 wherein selecting partial homophones comprises comparing the word phonetically with other words in the same language to identify similar sounding words based on the presence of matching phonemes and non-matching phonemes weighted by a statistical probability of confusing one for the other.

20. The system of any of examples 16-19 wherein selecting a best word alternative includes:

determining a best matching set of similar sounding words;

testing the best matching set of similar sounding words against the second statistical language model, which is the same as the first statistical language model; and

selecting the word that sounds most like the original word and has the highest statistical probability of occurring in the multiple original word text.

21. The system of any of examples 16-20 wherein selecting partial homophones comprises comparing the word phonetically with other words in the same language to identify similar sounding words based on the presence of matching phonemes and non-matching phonemes weighted by a statistical probability of confusing one for the other, and wherein selecting a best word alternative includes:

determining a best matching set of similar sounding words;

testing the best matching set of similar sounding words against the second statistical language model, which is the same as the first statistical language model; and

selecting the word that sounds most like the original word and has the highest statistical probability of occurring in the multiple original word text.

22. The system of any of examples 16-22 wherein the multiple original word text representing transcribed speech from an audio stream comprises multiple audio streams, each corresponding to speech from a different user.

Combining Speech Recognition Results

1. A method comprising:

obtaining an audio stream;

sending the audio stream to multiple speech recognition services that use different speech recognition algorithms to generate transcripts;

receiving a transcript from each of the multiple speech recognition services;

comparing words corresponding to a same utterance in the audio stream;

selecting highest confidence words for words that do not match based on the comparing; and

combining words that do match with the selected words to generate an output transcript.

2. The method of example 1 wherein the audio stream comprises multiple channels, each channel corresponding to a user on a call.

3. The method of example 2 wherein the words in the audio stream are correlated to user and time stamps.

4. The method of any of examples 1-3 wherein comparing words corresponding to a same utterance in the audio stream corresponds to individual words.

5. The method of any of examples 1-4 wherein comparing words corresponding to a same utterance in the audio stream corresponds to phrases.

6. The method of any of examples 1-5 wherein each word in the audio stream and corresponding transcript is correlated to a start and a stop time.

7. The method of any of examples 1-6 wherein selecting highest confidence words utilizes a context of the utterance and statistical properties of a language of the utterance to select the highest confidence words.

8. A method comprising:

receiving a transcript from each of multiple different speech recognition services corresponding to an audio stream containing speech utterances;

comparing words corresponding to a same utterance in the audio stream;

selecting highest confidence words for words that do not match based on the comparing; and

combining words that do match with the selected words to generate an output transcript.

9. The method of example 8 wherein the audio stream comprises multiple channels, each channel corresponding to a user on a call.

10. The method of example 9 wherein the words in the audio stream are correlated to user and time stamps.

11. The method of any of examples 8-10 wherein comparing words corresponding to a same utterance in the audio stream corresponds to individual words.

12. The method of any of examples 8-11 wherein comparing words corresponding to a same utterance in the audio stream corresponds to phrases.

13. The method of any of examples 8-12 wherein each word in the audio stream and corresponding transcript is correlated to a start and a stop time.

14. The method of any of examples 8-13 wherein selecting highest confidence words utilizes a context of the utterance and statistical properties of a language of the utterance to select the highest confidence words.

15. A computer readable storage device having instructions for execution by a computer to cause the computer to perform a method, the method comprising:

receiving a transcript from each of multiple different speech recognition services corresponding to an audio stream containing speech utterances;

comparing words corresponding to a same utterance in the audio stream;

selecting highest confidence words for words that do not match based on the comparing; and

combining words that do match with the selected words to generate an output transcript.

16. The method of example 15 wherein the audio stream comprises multiple channels, each channel corresponding to a user on a call.

17. The method of example 16 wherein the words in the audio stream are correlated to user and time stamps.

18. The method of any of examples 15-17 wherein comparing words corresponding to a same utterance in the audio stream corresponds to individual words.

19. The method of any of examples 15-18 wherein comparing words corresponding to a same utterance in the audio stream corresponds to phrases.

20. The method of any of examples 15-19 wherein each word in the audio stream and corresponding transcript is correlated to a start and a stop time.

21. The method of any of examples 15-20 wherein selecting highest confidence words utilizes a context of the utterance and statistical properties of a language of the utterance to select the highest confidence words.

22. A system comprising:

a processor;

a network connector coupled to the processor; and

a storage device coupled to the processor, the storage device having instructions for execution by the processor to cause the processor to perform a method comprising:

receiving a transcript from each of multiple different speech recognition services corresponding to an audio stream containing speech utterances;

comparing words corresponding to a same utterance in the audio stream;

selecting highest confidence words for words that do not match based on the comparing; and

combining words that do match with the selected words to generate an output transcript.

23. The method of example 22 wherein the audio stream comprises multiple channels, each channel corresponding to a user on a call.

24. The method of example 23 wherein the words in the audio stream are correlated to user and time stamps.

25. The method of any of examples 22-24 wherein comparing words corresponding to a same utterance in the audio stream corresponds to individual words.

26. The method of any of examples 22-25 wherein comparing words corresponding to a same utterance in the audio stream corresponds to phrases.

27. The method of any of examples 22-26 wherein each word in the audio stream and corresponding transcript is correlated to a start and a stop time.

28. The method of any of examples 22-27 wherein selecting highest confidence words utilizes a context of the utterance and statistical properties of a language of the utterance to select the highest confidence words.

### Compliance Detection Based on Transcript Analysis Examples

1. A method comprising:

receiving a transcript from a speech recognition service corresponding to an ongoing conference call audio stream containing speech utterances, wherein the transcript is annotated with identification of the speaker of each utterance;

providing the transcript to a speech metric generator; receiving an indication of compliance violations from the speech metric generator;

receiving metrics from the speech metric generator indicative of clarity, tone, energy, and dominance based on the transcript; and

providing the transcript, compliance violations, and descriptive labels corresponding to the received metrics in near real-time for display.

2. The method of example 1 wherein the audio stream comprises a separate audio channel for each speaker, and time stamps indicating a time for each utterance during the call.

3. The method of example 2 wherein the metrics comprise a numerical score for each metric.

4. The method of any of examples 1-3 wherein the metric for clarity is representative of a detected precision and detail of utterances by a user.

5. The method of any of examples 1-4 wherein the metric for tone is representative of the use of negative adjectives in utterances by a user.

6. The method of any of examples 1-5 wherein the metric for energy is representative of detected emotionally evocative utterances by a user.

7. The method of any of examples 1-6 wherein the metric for dominance is representative of directness of utterances by a user.

8. The method of any of examples 1-7 wherein the descriptive labels comprise the terms clarity, tone, energy, and dominance coupled with a numerical score for each on a common scale.

9. A computer readable storage device having instructions for execution by a computer to cause the computer to perform a method, the method comprising:

receiving a transcript from a speech recognition service corresponding to an ongoing conference call audio stream containing speech utterances, wherein the transcript is annotated with identification of the speaker of each utterance;

providing the transcript to a speech metric generator;

receiving an indication of compliance violations from the speech metric generator;

receiving metrics from the speech metric generator indicative of clarity, tone, energy, and dominance based on the transcript; and

providing the transcript, compliance violations, and descriptive labels corresponding to the received metrics in near real-time for display.

10. The method of example 9 wherein the audio stream comprises a separate audio channel for each speaker, and time stamps indicating a time for each utterance during the call.

11. The method of example 10 wherein the metrics comprise a numerical score for each metric.

12. The method of any of examples 9-11 wherein the metric for clarity is representative of a detected precision and detail of utterances by a user.

13. The method of any of examples 9-12 wherein the metric for tone is representative of the use of negative adjectives in utterances by a user.

14. The method of any of examples 9-13 wherein the metric for energy is representative of detected emotionally evocative utterances by a user.

15. The method of any of examples 9-14 wherein the metric for dominance is representative of directness of utterances by a user.

16. The method of any of examples 9-15 wherein the descriptive labels comprise the terms clarity, tone, energy, and dominance coupled with a numerical score for each on a common scale.

17. A system comprising:

a processor;

a network connector coupled to the processor; and

a storage device coupled to the processor, the storage device having instructions for execution by the processor to cause the processor to perform a method comprising:

receiving a transcript from a speech recognition service corresponding to an ongoing conference call audio stream containing speech utterances, wherein the transcript is annotated with identification of the speaker of each utterance;

providing the transcript to a speech metric generator;

receiving an indication of compliance violations from the speech metric generator;

receiving metrics from the speech metric generator indicative of clarity, tone, energy, and dominance based on the transcript; and

providing the transcript, compliance violations, and descriptive labels corresponding to the received metrics in near real-time for display.

18. The method of example 17 wherein the audio stream comprises a separate audio channel for each speaker, and time stamps indicating a time for each utterance during the call.

19. The method of example 18 wherein the metrics comprise a numerical score for each metric.

20. The method of any of examples 17-19 wherein the metric for clarity is representative of a detected precision and detail of utterances by a user.

21. The method of any of examples 17-20 wherein the metric for tone is representative of the use of negative adjectives in utterances by a user.

22. The method of any of examples 17-21 wherein the metric for energy is representative of detected emotionally evocative utterances by a user.

23. The method of any of examples 17-22 wherein the metric for dominance is representative of directness of utterances by a user.

24. The method of any of examples 17-23 wherein the descriptive labels comprise the terms clarity, tone, energy, and dominance coupled with a numerical score for each on a common scale.

Transcription Data Conversion and Export Examples

1. A method comprising:

receiving a transcript from a speech recognition service corresponding to an ongoing conference call audio stream containing speech utterances, wherein the transcript is annotated with contact information identifying each speaker of each utterance, time, duration, call information, and data recorded relative to the call;

indexing the text of the speech utterances in the transcript to the audio stream;

formatting the indexed transcript for a business intelligence system; and

transferring the formatted indexed transcript to the business intelligence system.

2. The method of example 1 wherein the indexed transcript is formatted for seamless integration into the business intelligence infrastructure.

3. The method of any of examples 1-2 wherein data recorded relative to the call comprises data entered into a computer by a person on the call.

4. The method of any of examples 1-3 wherein the audio stream comprises a separate channel of audio for each speaker on the call.

5. The method of any of examples 1-4 wherein the formatted indexed transcript is transferred to the business intelligence system in a manner such that it is searchable by the business intelligence system.

6. The method of any of examples 1-5 wherein indexing the text comprises identifying keywords in the text.

7. The method of any of examples 1-band further comprising providing the audio stream to the business intelligence system.

8. The method of example 7 wherein the audio stream is provided to the business intelligence system such that the audio stream is accessible by a user of the business intelligence system via the transferred formatted indexed transcript.

9. A computer readable storage device having instructions for execution by a computer to cause the computer to perform a method, the method comprising:

receiving a transcript from a speech recognition service corresponding to an ongoing conference call audio stream containing speech utterances, wherein the transcript is annotated with contact information identifying each speaker of each utterance, time, duration, call information, and data recorded relative to the call;

indexing the text of the speech utterances in the transcript to the audio stream;

formatting the indexed transcript for a business intelligence system; and

transferring the formatted indexed transcript to the business intelligence system.

10. The method of example 9 wherein the indexed transcript is formatted for seamless integration into the business intelligence infrastructure.

11. The method of any of examples 9-10 wherein data recorded relative to the call comprises data entered into a computer by a person on the call.

12. The method of any of examples 9-11 wherein the audio stream comprises a separate channel of audio for each speaker on the call.

13. The method of any of examples 9-12 wherein the formatted indexed transcript is transferred to the business intelligence system in a manner such that it is searchable by the business intelligence system.

14. The method of any of examples 9-13 wherein indexing the text comprises identifying keywords in the text.

15. The method of any of examples 9-14 and further comprising providing the audio stream to the business intelligence system.

16. The method of example 15 wherein the audio stream is provided to the business intelligence system such that the audio stream is accessible by a user of the business intelligence system via the transferred formatted indexed transcript.

17. A system comprising:

a processor;

a network connector coupled to the processor; and

a storage device coupled to the processor, the storage device having instructions for execution by the processor to cause the processor to perform a method comprising:

receiving a transcript from a speech recognition service corresponding to an ongoing conference call audio stream containing speech utterances, wherein the transcript is annotated with contact information identifying each speaker of each utterance, time, duration, call information, and data recorded relative to the call;

indexing the text of the speech utterances in the transcript to the audio stream;

formatting the indexed transcript for a business intelligence system; and

transferring the formatted indexed transcript to the business intelligence system.

18. The method of example 17 wherein the indexed transcript is formatted for seamless integration into the business intelligence infrastructure.

19. The method of any of examples 17-18 wherein data recorded relative to the call comprises data entered into a computer by a person on the call.

20. The method of any of examples 17-19 wherein the audio stream comprises a separate channel of audio for each speaker on the call.

21. The method of any of examples 17-20 wherein the formatted indexed transcript is transferred to the business intelligence system in a manner such that it is searchable by the business intelligence system.

22. The method of any of examples 17-21 wherein indexing the text comprises identifying keywords in the text.

23. The method of any of examples 17-22 and further comprising providing the audio stream to the business intelligence system.

24. The method of example 23 wherein the audio stream is provided to the business intelligence system such that the audio stream is accessible by a user of the business intelligence system via the transferred formatted indexed transcript.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method comprising:
processing multiple individual participant speech in a conference call with an audio speech recognition system to create a transcript for each participant;
assembling the transcripts into a single transcript having participant identification for each speaker in the single transcript; and
making the transcript searchable.

2. The method of claim 1 and further comprising annotating the transcript with a date and time for each speaker.

3. The method of claim 2 and further comprising storing an audio recording of the speech by each participant correlated to the annotated transcript for playback.

4. The method of claim 3 wherein the transcript is searchable by speech, speaker, date, and time to identify and play corresponding portions of the audio recording.

5. The method of claim 1 and further comprising providing messaging alerts to a participant as a function of the transcript.

6. The method of claim 5 wherein a messaging alert is sent to a participant when the participant's name is spoken and transcribed such that it occurs in the transcript.

7. The method of claim 5 wherein providing messaging alerts comprises:
identifying a portion of the transcript meeting a search string;
identifying an address corresponding to the search string;
creating a message using the portion of the transcript meeting the search string; and
sending the message to the identified address.

8. The method of claim 7 wherein the address comprises an email address.

9. The method of claim 7 wherein the portion of the transcript contains a name of a person occurring in the identified portion of the transcript, and wherein the identified address corresponds to the person.

10. The method of claim 7 wherein the portion of the transcript contains keywords included in a search string by person, and wherein the address corresponds to an address of the person.

11. The method of claim 5 wherein the messages are sent in near real time as the transcript of the conference call is generated during the conference call.

12. The method of claim 5 wherein the messaging alert points to a portion of the transcript giving rise to the messaging alert such that the portion of the transcript is displayable to the participant receiving the alert.

13. A computer readable storage device having programming stored thereon to cause a computer to perform a method, the method comprising:
processing multiple individual participant speech in a conference call with an audio speech recognition system to create a transcript for each participant;
assembling the transcripts into a single transcript having participant identification for each speaker in the single transcript; and
making the transcript searchable.

14. The computer readable storage device of claim 13 wherein the method further comprises:
annotating the transcript with a date and time for each speaker; and
storing an audio recording of the speech by each participant correlated to the annotated transcript for playback, wherein the transcript is searchable by speech, speaker, date, and time to identify and play corresponding portions of the audio recording.

15. The computer readable storage device of claim 13 wherein the method further comprises providing messaging alerts to a participant as a function of the transcript.

16. The computer readable storage device of claim 13 wherein the method further comprises sending a messaging alert to a participant when the participant's name is spoken and transcribed such that it occurs in the transcript.

17. The computer readable storage device of claim 13 wherein providing messaging alerts comprises:
identifying a portion of the transcript meeting a search string;
identifying an address corresponding to the search string;
creating a message using the portion of the transcript meeting the search string; and
sending the message to the identified address.

18. A system comprising:
a mixing server coupled to a network to receive audio streams from multiple users;
an transcription audio output to provide the audio streams to a transcription system;
a data input to receive text from the transcription system corresponding to the audio streams provided to the transcription system;
a transcript generator to receive the text, assemble the text into a single transcript having participant identification for each speaker in the single transcript, and make the transcript searchable; and
user connections to provide the audio and the transcript to multiple users.

19. The system of claim 18 and further comprising a transcript database coupled to receive the transcript and archive the transcript in a searchable form.

20. The system of claim 18 wherein the mixing server further comprises:
a first queue coupled to the transcription audio output from which the transcription system draws audio streams to transcribe; and
a second queue to receive text from the transcription system and meta data associated with utterances in the audio streams correlated to the text.
